(19) United States
(12) Patent Application Publication
(10) Pub. No.: US 2026/0221784 A1
(43) Pub. Date: Jul. 30, 2026

(54) POWER PRECHARGE SYSTEM FOR MULTIPLE CHANNELS

(71) Applicant: Eaton Intelligent Power Limited, Dublin 4 (IE)

(72) Inventors: Jacob William Green, Clackamas, OR (US); Tissaphern Mirfakhrai, Farmington Hills, MI (US); Rocendo Bracamontes Del Toro, Sherwood, OR (US); Payam Naghshtabrizi, Royal Oak, MI (US); Tae Hyung Kim, Ann Arbor, MI (US)

(21) Appl. No.: 19/148,930

(22) PCT Filed: Jan. 12, 2024
(86) PCT No.: PCT/EP2024/025020

§ 371 Date: Jul. 17, 2025

Related U.S. Application Data
(60) Provisional application No. 63/439,743, filed on Jan. 18, 2023.

(51) Int. Cl. H02J 7/34; H02H 9/02

(52) U.S. Cl. CPC H02J 7/345; H02H 9/02

(57) ABSTRACT

A power precharge system is presented. The power precharge system includes a single precharge circuit including an output that carries a constant current and a switching circuit coupled to the output of the precharge circuit. The switching circuit includes multiple switches, each switch of connected to one separate output channel of multiple output channels, and a controller connected to the multiple switches. The controller controls sharing of the constant current between the output channels by independently opening and closing each switch. A method for operating a precharge circuit is also presented.

### STATEMENT REGARDING GOVERNMENT FUNDING

This invention was made with government support under U.S. Army TARDEC Phase II project, contract number 2019140-141043. The Federal Government has certain rights to this invention.

### BACKGROUND

Precharge circuits are often used to limit an inrush of current into a circuit of a high voltage system, for example. In the context of this application, high voltage is defined as 600 to 1200 V DC. Such high voltage systems include, but are not limited to, electric vehicles, on-board chargers, power supplies, DC microgrid controllers, and power distribution units. If not limited by a precharge circuit or other mechanism, the inrush of current may damage the system components of the circuit. For example, a current spike can cause contacts of an electrical circuit to weld closed.

Precharge circuits for high voltage systems may be resistive or non-resistive. Resistive precharge circuits utilize a resistor to slowly charge a capacitor inside the circuit before powering up. Non-resistive precharge circuits, or resistor-less precharge circuits, use alternative methods and systems for charging the capacitor without utilizing a resistor which may introduce a lossy element that consumes power during normal operation.

### BRIEF SUMMARY

A power precharge system for multiple channels that enables a sharing of a precharge from a single precharge circuit with multiple outputs is described.

A power precharge system for multiple channels includes a single precharge circuit including an output that carries a constant DC current and a switching circuit coupled to the output of the precharge circuit. The switching circuit includes multiple switches, each switch connected to one separate output channel of multiple output channels, and a controller connected to the multiple switches. The controller controls sharing of the constant current between the output channels by independently opening and closing each switch.

A method for operating a switching circuit for a power precharge system for multiple channels can include precharging a charge storage device in a single precharge circuit to provide a constant current and controlling, by the controller, a sharing of the constant current between the output channels by independently opening and closing each switch of the multiple switches. The single precharge circuit is connected to the input of the switching circuit, wherein the switching circuit comprises multiple switches, each switch of the multiple switches connected to one separate output channel. The controller is connected to each of the multiple switches.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a circuit diagram of an example resistive precharge circuit.

FIG. 2 illustrates a circuit diagram of an example resistor-less precharge circuit.

FIG. 3 illustrates a circuit diagram of the precharge circuit for multiple channels in accordance with one embodiment.

FIG. 4 illustrates a switch and channel line in accordance with one embodiment.

FIG. 5 illustrates a method of operating a precharge circuit of a power precharge system.

### DETAILED DESCRIPTION

A power precharge system for multiple channels that enables a sharing of a precharge from a single precharge circuit with multiple outputs is described. Currently, in high voltage application circuitry such as for an electric vehicle, there is a single precharge circuit per output channel resulting in extensive redundant circuitry on a circuit board. In addition, the components of these precharge circuits are expensive and take up considerable space on the circuit board. Thus, by sharing the output precharge of one precharge circuit between multiple output channels under control of a switching circuit as described herein, it is possible to improve area efficiencies and reduce number of parts.

A switching circuit for a power precharge system is provided that utilizes an output of a constant DC current from a single precharge circuit and multiplexes the precharge to multiple output channels. The switching circuit can provide multiple channels with precharge current using a single precharge circuit. The switching circuit is easy to scale on the hardware and controls. By utilizing only one precharge circuit, space on the circuit board is optimized which minimizes system cost.

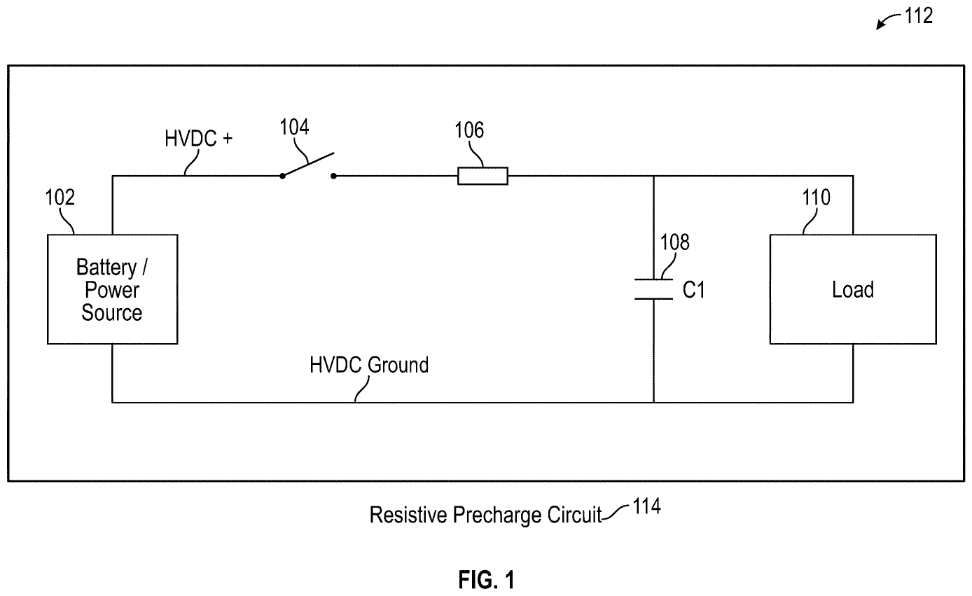

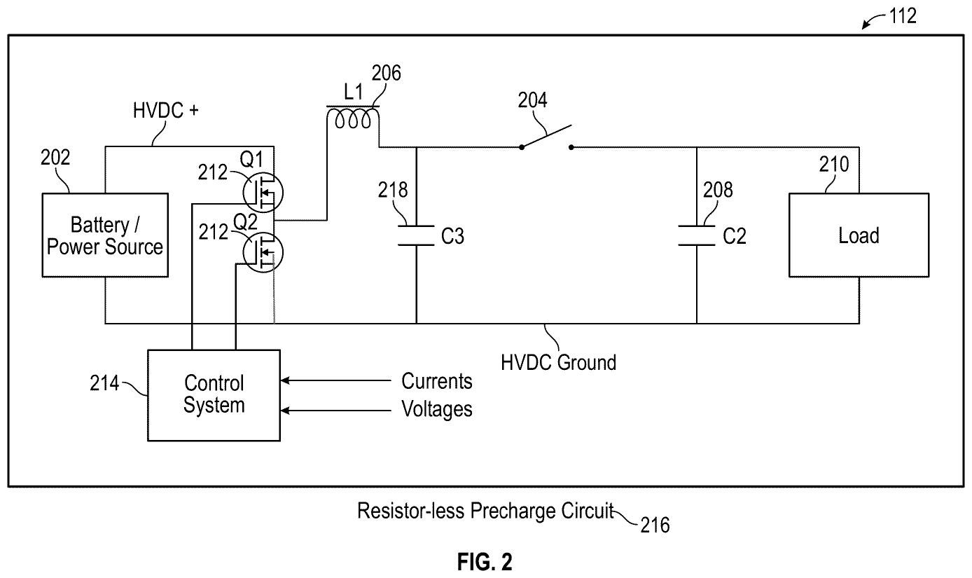

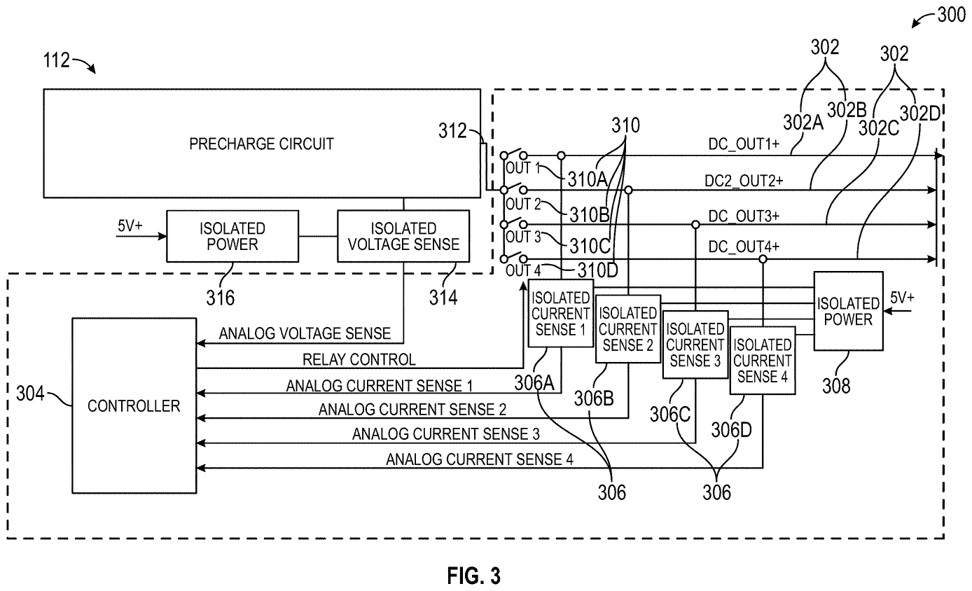

FIG. 3 illustrates a circuit diagram of the precharge circuit for multiple channels in accordance with one embodiment; FIG. 1 illustrates a circuit diagram of an example resistive precharge circuit; and FIG. 2 illustrates a circuit diagram of an example resistor-less precharge circuit.

Referring to FIG. 3, a power precharge system includes a single precharge circuit 112 and a power switching circuit 300 that can multiplex a provided precharge from the single precharge circuit 112 to multiple channels. Both FIG. 1 and FIG. 2 illustrate circuit diagrams of example precharge circuits that can be interchangeably utilized in the single precharge circuit 112, among other types of precharge circuits and configurations, in the power precharge system and coupled to switching circuit 300.

For example, FIG. 1 shows an example resistive precharge circuit. The resistive precharge circuit 114 includes a battery 102, or other power source, that provides a high voltage, such as 600V DC, for the resistive precharge circuit 114. The resistive precharge circuit 114 is suitable for a high voltage system such as an electric vehicle. The battery 102 can provide DC power to a DC link capacitor 108 through a resistor 106 via a precharge contactor 104. The precharge contactor 104 is a control device that can provide galvanic isolation between battery 102 and a load 110. The control device forming the precharge contactor 104 may be a relay, a switch, a semiconductor device, etc. Resistor 106 is positioned adjacent to the precharge contactor 104 to limit the current through the circuit when the DC link capacitor 108 is being charged by battery 102, which occurs when the precharge contactor 104 is closed. The DC link capacitor 108 can be considered to be in parallel with the load 110. In some cases, the capacitance of the DC link capacitor 108 is in a range of 1-10 mF. The load 110, as shown in FIG. 1, can represent a single output channel.

For a resistive precharge circuit such as shown in FIG. 1, prior to a precharging operation, the DC link capacitor 108 is discharged and the precharge contactor 104 is open to disconnect the battery 102 from the load 110, as seen in FIG. 1. In a precharging operation, the precharge contactor 104 is closed so that current flows through the resistor 106 in order to supply charging current to the DC link capacitor 108. After sufficient charging, the voltage across the DC link capacitor 108 is essentially the same as the battery voltage. The precharge contactor 104 is opened and the resistive precharge circuit 114 is then ready to provide a precharge to its load 110, as selected by switching circuit 300, at the output of precharge circuit 112 (embodied in this example as resistive precharge circuit 114). The output of the resistive precharge circuit 114 can carry a constant DC current. It should be understood that the resistive precharge circuit 114 of FIG. 1 is for illustrative purposes only as other types of resistive precharge circuits may be employed in the proposed system and method. In addition, while the example resistive precharge circuit 114 is a resistive precharge circuit, i.e., it utilizes a resistor to restrict the flow of current to the load 110, a non-resistive precharge circuit, as shown in FIG. 2, may also be utilized. In an embodiment, the resistive precharge circuit 114 is a solid state precharge circuit.

As another example, FIG. 2 shows an example resistor-less precharge circuit. The resistor-less precharge circuit 216 of FIG. 2 is also for illustrative purposes only as other types of resistor-less precharge circuits may be employed in the proposed system and method. Resistor-less precharge circuit 216 may be controlled by a control system 214. Referring to FIG. 2, resistor-less precharge circuit 216 includes a battery 202, or other power source, that provides a high voltage, such as 600 V DC, to the resistor-less precharge circuit 216. The resistor-less precharge circuit 216 is suitable for precharging a high voltage system such as an electric vehicle. The battery 202 provides DC power to a DC link capacitor 208 via circuitry controlled by a control system 214. In some cases, the capacitance of the DC link capacitor 208 is in a range of 1-10 mF. A precharge contactor 204 is included to provide selective galvanic isolation between battery 202 and the DC link capacitor 208/load 210 portion of the resistor-less precharge circuit 216. The precharge contactor 204 may be a relay, a switch, a semiconductor device, etc.

Instead of a resistor, the resistor-less precharge circuit 216 includes transistors 212, inductor 206, and a small (e.g., on the order of 10 μF) capacitor 218. These electrical components (transistors 212, inductor 206, and capacitor 218) enable a bidirectional current flow that can pull energy back into battery 202.

For a resistor-less precharge circuit 216 such as shown in FIG. 2, in a precharging operation, the DC link capacitor 208 receives the DC power from the battery 202 as filtered by electrical components controlled by control system 214 when the precharge contactor 204 is closed. After sufficient charging of the DC link capacitor 208, the precharge contactor 204 is opened and the resistor-less precharge circuit 216 is then ready to provide precharge to its load 210, as selected by switching circuit 300, at the output of the precharge circuit 112 (embodied in this example as resistor-less precharge circuit 216). Capacitor 218 is also positioned to receive DC power from the battery 202. However, capacitor 218 is utilized for “no load” situations when the precharge contactor 204 is opened under a no load condition. A current sensor and/or a voltage sensor (not shown) each having a corresponding power source may be included in the precharge circuit to measure a respective input current or input voltage to the resistor-less precharge circuit 216, which is used by control system 214 in operating the switches 212. In an embodiment, the resistor-less precharge circuit 216 is a solid state precharge circuit.

Returning to FIG. 3, switch 310 receives the output of single precharge circuit 312. Switch 310 comprises multiple switches 310A, 310B, 310C, and 310D. The output of precharge circuit 312 is connected to the multiple switches 310A, 310B, 310C, and 310D. Each switch 310A, 310B, 310C, and 310D of the multiple switches may be a relay switch. Each switch 310A, 310B, 310C, and 310D is connected to a separate output channel 302 of multiple output channels 302A, 302B, 302C, 302D, respectively. Four output channels 302A, 302B, 302C, 302D are shown in the embodiment of FIG. 3, however, the number of output channels is not limited thereto. For example, the number of output channels can range from 2 to 10. A controller 304 is connected to each switch 310A, 310B, 310C, 310D of the multiple switches to control sharing of the constant current between the output channels 302A, 302B, 302C, 302D by independently opening and closing the corresponding switch.

In an embodiment, the switching circuit 300 includes multiple current sensors 306, one current sensor 306A, 306B, 306C, 306D positioned on each output channel line between the corresponding switch 310A, 310B, 310C, 310D and the output channel 302A, 302B, 302C, 302D to measure the current on the channel line. The current information on each channel line is transmitted to the controller 304. The current sensors 306A, 306B, 306C, 306D are powered by an isolated power source 308 which may be a low voltage power source, such as, for example, a 5V power source. The controller 304 can utilize the current information on each channel line to monitor the current and control the sharing of the current between the output channels 302A, 302B, 302C, 302D. Additionally, when the current is measured, via the respective current sensor 306, to be above a threshold, the controller 304 opens the respective switch 310 to prevent flow of current to the corresponding output channel 302.

Alternately or in addition, the switching circuit 300 can include a voltage sensor 314, to measure the voltage on the channel line. The voltage is transmitted to the controller 304. The voltage sensor 314 is powered by an isolated power source 316 which may be a low voltage power source, such as, for example, a 5V power source.

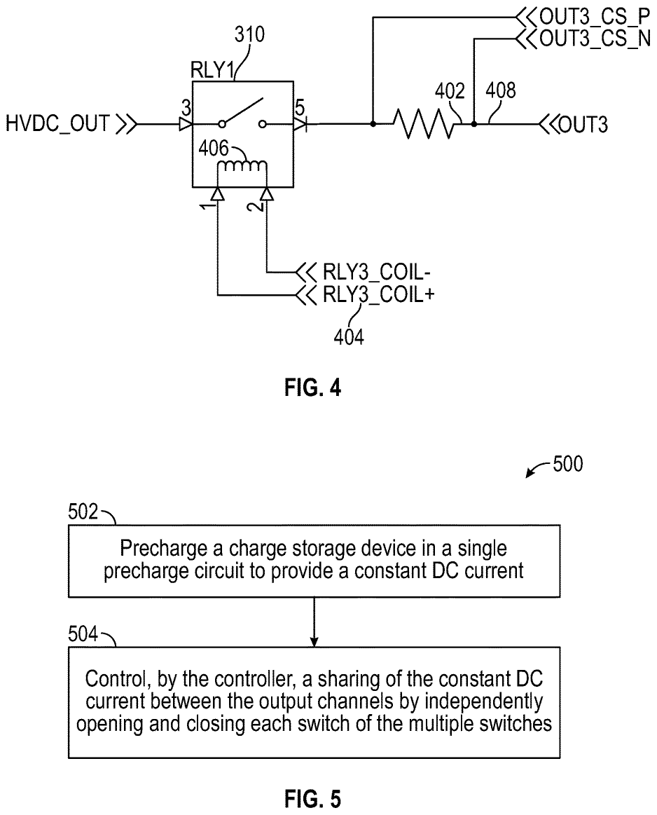

FIG. 4 illustrates a switch and channel line in accordance with one embodiment. Switch 310 can represent one of the switches 310A, 310B, 310C, 310D of FIG. 3. Switch 310 is shown as a relay switch; however, the switches of switching circuit 300 are not limited thereto. Referring to FIG. 4, in order to open the switch 310, a voltage 404 is applied across the voltages relay coils 406, (e.g., by control of controller 304 of FIG. 3). When the switch 310 is connected to precharge circuit 112, the voltage source is the voltage across the DC link capacitor (e.g., DC link capacitor 108, DC link capacitor 208). Resistor 402 is used by a current sensor (e.g., connected at OUT3 CS P and OUT3 CS N) to measure the current on the channel line 408.

FIG. 5 shows a method of operating a precharge circuit of a power precharge system. Method 500 can be performed when utilizing a precharge circuit with the switching circuit such as described in FIG. 3. The method 500 includes precharging (502) a storage device, such as the DC link capacitor, in a single precharge circuit to provide a constant DC current to the input of a switching circuit, wherein the switching circuit comprises a switch comprising multiple switches each switch connected to one separate output channel, and a controller connected to each of the multiple switches. Method 500 further controls (504), by the controller, a sharing of the constant current between the output channels by independently opening and closing each switch, for example, based on operations of the loads and/or current on the channel lines.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A power precharge system, comprising:
a single precharge circuit including an output that carries a constant DC current; and
a switching circuit coupled to the output of the precharge circuit, comprising:
multiple switches, each switch of the switching circuit connected to one separate output channel of multiple output channels, and
a controller connected to the multiple switches,
wherein the controller controls sharing of the constant DC current between the multiple output channels by independently opening and closing each switch.

2. The power precharge system of claim 1, wherein the switching circuit further comprises multiple current sensors, and wherein each current sensor is positioned in a channel line between each switch and the corresponding output channel to measure a current on the channel line.

3. The power precharge system of claim 2, wherein, in response to the current measured on each channel line, the controller controls the sharing of the constant DC current between the output channels.

4. The power precharge system of claim 1, wherein the single precharge circuit is a resistive precharge circuit.

5. The power precharge system of claim 1, wherein the single precharge circuit is a resistor-less precharge circuit.

6. The power precharge system of claim 5, wherein the single precharge circuit includes electrical components that enable a bidirectional current flow into and out of the single precharge circuit.

7. The power precharge system of claim 1, wherein the single precharge circuit is a solid state precharge circuit.

8. The power precharge system of claim 1, wherein the precharge circuit comprises a battery and a precharge contactor electrically connected to the battery, and wherein the battery provides a voltage in a range of 600 to 1200 V DC.

9. The power precharge system of claim 1, wherein a number of output channels is in a range of 2 to 10.

10. A method for operating a precharge circuit of a power precharge system comprising a single precharge circuit and a switching circuit coupled to the output of the precharge circuit, the method comprising:
precharging a charge storage device in the single precharge circuit to provide a constant DC current, wherein the single precharge circuit is connected to an input of the switching circuit, wherein the switching circuit comprises multiple switches, each switch of the multiple switches connected to one separate output channel of multiple channels, and a controller connected to each of the multiple switches; and
controlling, by the controller, a sharing of the constant DC current between the multiple output channels by independently opening and closing each switch of the multiple switches of the switching circuit.

11. The method of claim 10, further comprising measuring a current utilizing a current sensor positioned in a channel line between each switch and the corresponding output channel.

12. The method of claim 11, further comprising monitoring, by the controller, the current on each channel line.

13. The method of claim 12, wherein, when the current measured on a particular channel line is above a threshold, the controller opens the switch corresponding to that channel line.

14. The method of claim 10, further comprising monitoring, by the controller, a voltage on each channel line.
